(19) United States
(12) Patent Application Publication
(10) Pub. No.: US 2015/0219961 A1
(43) Pub. Date: Aug. 6, 2015

(54) HIGH LIGHT TRANSMITTANCE AND COLOR ADJUSTING CIRCULAR POLARIZING PLATE AND REFLECTIVE LIQUID CRYSTAL DISPLAYS COMPRISING THE SAME

(71) Applicant: LG CHEM, LTD., Seoul (KR)

(72) Inventors: Sung-Hyun Nam, Daejeon (KR); Kyun-Il Rah, Daejeon (KR)

(21) Appl. No.: 14/232,192

(22) PCT Filed: Jul. 23, 2013
(86) PCT No.: PCT/KR2013/006552

§ 371 Date: Jan. 10, 2014

(30) Foreign Application Priority Data
Jul. 23, 2012 (KR) 10-2012-0080092
Jul. 22, 2013 (KR) 10-2013-0086069

(51) Int. Cl. G02F 1/1335; G02B 5/30

(52) U.S. Cl. CPC G02F 1/133528; G02F 1/133553; G02B 5/3083; G02B 5/3016; G02F 2001/133541

(57) ABSTRACT

There is provided a circular polarizing plate for a reflective liquid crystal display, the circular polarizing plate including: a polarizing plate including a polarizer having an absorption axis forming an angle of 85° to 95° with respect to an alignment direction of liquid crystals of a liquid crystal cell, disposed toward an upper substrate, and a ¼ wavelength plate having an optical axis forming an angle of 130° to 140° with respect to the alignment direction of the liquid crystals of the liquid crystal cell, disposed toward the upper substrate, wherein the ¼ wavelength plate has reverse wavelength dispersion characteristics.

### TECHNICAL FIELD

The present invention relates to a circular polarizing plate for a reflective liquid crystal display, and more particularly, a circular polarizing plate for a reflective liquid crystal display, capable of implementing improved transmittance and color senses, and a reflective liquid crystal display including the same.

### BACKGROUND ART

Liquid crystal displays (LCDs) may be classified into transmissive liquid crystal displays using a backlight as a light source and reflective liquid crystal displays using external natural light or artificial light as a light source.

Transmissive liquid crystal displays may be advantageous in that bright images may be implemented therewith, even in relatively dark external environments due to the use of a backlight as a light source, while having defects such as a screen recognition failure in bright places and high power consumption. On the contrary, reflective liquid crystal displays may use natural external light or artificial light as a light source, leading to low power consumption, and may be advantageously thin and lightweight because they have no backlight mounted therein. Due to these advantages, recently, reflective liquid crystal displays have been increasingly employed in mobile terminals such as cellular phones.

According to the related art, a reflective liquid crystal display generally includes an upper substrate and a lower substrate formed of a transparent material; a liquid crystal cell interposed between the upper substrate and the lower substrate; a reflective plate formed below the lower substrate or formed between the lower substrate and the liquid crystal cell; a ¼ retardation plate formed on the upper substrate; and a polarizing plate disposed on the retardation plate.

However, in the case of the reflective liquid crystal display according to the related art, chrominance may be easily generated due to the occurrence of a difference in paths taken by transmitted light and reflective light, to consequently generate a yellowish phenomenon in which a screen exhibits yellow color, thereby leading to deterioration in the color sense. Further, a bluish phenomenon of generating blue color sense in dark states may be caused. In addition, transmittance of light may be deteriorated to result in low luminance, as compared to the case of the transmissive liquid crystal display.

### DISCLOSURE

### Technical Problem

An aspect of the present invention provides a circular polarizing plate for a reflective liquid crystal display having improved transmittance while allowing for excellent color senses by reducing a yellowish phenomenon and a bluish phenomenon, and a reflective liquid crystal display including the same.

Aspects of the present invention are not limited thereto, and may be understood from the overall description of the specification. Additional aspects of the present invention could be understood by a person having ordinary skill in the art without difficulties.

### Technical Solution

According to an aspect of the present invention, there is provided a circular polarizing plate for a reflective liquid crystal display, the circular polarizing plate including: a polarizing plate including a polarizer having an absorption axis forming an angle of 85° to 95° with respect to an alignment direction of liquid crystals of a liquid crystal cell, disposed toward an upper substrate; and a ¼ wavelength plate having an optical axis forming an angle of 130° to 140° with respect to the alignment direction of the liquid crystals of the liquid crystal cell, disposed toward the upper substrate, wherein the ¼ wavelength plate has reverse wavelength dispersion characteristics.

The ¼ wavelength plate may satisfy formula (4) and formula (5).

0.5≦Rᵢₙ(450)/Rᵢₙ(550)<1.0 Formula (4)

1.0<Rᵢₙ(650)/Rᵢₙ(550)≦1.3 Formula (5)

where, Rᵢₙ(450) denotes an in-plane retardation value at a wavelength of 450 nm, Rᵢₙ(550) denotes an in-plane retardation value at a wavelength of 550 nm, and Rᵢₙ(650) denotes an in-plane retardation value at a wavelength of 650 nm.

The polarizer may have a transmittance of 43 to 47%.

The polarizer may have a color a value of −1 to −0.6 and a color b value of 0.3 to 2.5 in a CIE color coordinate system.

The ¼ wavelength plate may be a uniaxially stretched film. The ¼ wavelength plate may be one of a uniaxially stretched cycloolefin polymer (COP) film, a polycarbonate (PC) film, a liquid crystal film, and an acrylic film.

The ¼ wavelength plate may have an in-plane retardation value of 120 to 170 nm at a wavelength of 550 nm.

The ¼ wavelength plate may have a thickness direction retardation value of −20 to 150 nm at a wavelength of 550 nm.

According to another aspect of the present invention, there is provided a reflective liquid crystal display including: an upper substrate; a lower substrate disposed to be opposed to the upper substrate, having a predetermined interval therebetween; a liquid crystal cell interposed between the upper substrate and the lower substrate; a reflective plate disposed between the lower substrate and the liquid crystal cell or disposed below the lower substrate; and the circular polarizing plate disposed on the upper substrate, the circular polarizing plate including: the polarizing plate including the polarizer having the absorption axis forming an angle of 85° to 95° with respect to the alignment direction of the liquid crystals of the liquid crystal cell, disposed toward the upper substrate, and the ¼ wavelength plate having the optical axis forming an angle of 130° to 140° with respect to the alignment direction of the liquid crystals of the liquid crystal cell, disposed toward the upper substrate, wherein the ¼ wavelength plate has reverse wavelength dispersion characteristics.

The reflective liquid crystal display may be an in-plane switching (IPS) mode liquid crystal display or an electrically controlled birefringence (ECB) mode liquid crystal display.

All of features of the invention are not described in the above-described objects. Various features of the present invention and advantages and effects obtained thereby will be understood in more detail with reference to the following concrete embodiments.

### Advantageous Effects

When a circular polarizing plate is applied to a reflective liquid crystal device, a contrast ratio may be improved to improve visibility, and yellow color sense may be reduced as well as a reduction in blue color sense in dark states, to thereby implement excellent color senses.

### DESCRIPTION OF DRAWINGS

FIG. 1 shows photographs illustrating visual sensitivity characteristics according to retardation values of circular polarizing plates according to Experimental Example 2.

FIG. 2 is a graph illustrating light room contrast ratios at the time of using circular polarizing plates according to Example and Comparative Examples 1 to 6.

FIG. 3 is a graph illustrating dark room contrast ratios at the time of using the circular polarizing plates according to Example and Comparative Examples 1 to 6.

FIG. 4 is a graph illustrating contrast ratios according to variations in Rth(550) of a ¼ wavelength plate.

### BEST MODE

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In order to develop a circular polarizing plate having improved color sense in dark states and a reflective liquid crystal display including the same, as a result of repeated research, the inventors of the invention found that the above-described objects may be achieved by using a circular polarizing plate in which an absorption axis of a polarizer and an optical axis of a ¼ wavelength plate are arranged to form certain angles with respect to an alignment direction of liquid crystals of a liquid crystal cell, wherein the ¼ wavelength plate has reverse wavelength dispersion characteristics, to thereby complete the invention.

More specifically, a circular polarizing plate for a reflective liquid crystal display according to an embodiment of the present invention may include a polarizing plate including a polarizer having an absorption axis forming an angle of 85° to 95° with respect to an alignment direction of liquid crystals of a liquid crystal cell, disposed toward an upper substrate, and a ¼ wavelength plate having an optical axis forming an angle of 130° to 140° with respect to the alignment direction of liquid crystals of the liquid crystal cell, disposed toward the upper substrate, wherein the ¼ wavelength plate has reverse wavelength dispersion characteristics.

According to the result of the inventors' research, as in the embodiment of the present invention, when the absorption axis of the polarizer and the optical axis of the ¼ wavelength plate are arranged to form angles of 85° to 95° and 130° to 135°, respectively, with respect to the alignment direction of the liquid crystals of the liquid crystal cell, disposed toward the upper substrate, it could be seen that the color of white light is shifted from a yellow region to a blue region to remarkably improve visibility and color sense. Further, as in the embodiment of the present invention, when a film having reverse wavelength dispersion characteristics is used as the ¼ wavelength plate, clear black color may be realized as compared to the case of using a film having normal or flat wavelength dispersion characteristics to thereby remarkably improve a contrast ratio.

Hereinafter, the circular polarizing plate according to the embodiment of the present invention will be described in detail. As described above, the circular polarizing plate according to the embodiment of the present invention may include (i) the polarizing plate including the polarizer and (ii) the ¼ wavelength plate.

In this case, the polarizer refers to an optical element enabling only light polarized in a specific direction to pass therethrough, and may generally have a structure in which polyvinyl alcohol (hereinafter, referred to as PVA)-based molecular chains are aligned in a certain direction and an iodine compound or dichroic polarizing material is included therein. The polarizer may be manufactured by a method of dyeing a PVA film with an iodine or dichroic dye and then stretching the film in a predetermined direction and then crosslinking. In this case, the degree of polymerization of PVA is not particularly limited, but in consideration of the freedom of molecular movements and flexible mixture with materials contained therein, may be about 1,000 to 10,000 and preferably, may be about 1,500 to 5,000.

Meanwhile, according to the embodiment of the present invention, the absorption axis of the polarizer may be disposed to form an angle of 85° to 95° with respect to the alignment direction of the liquid crystals of the liquid crystal cell, disposed toward the upper substrate. In this case, the term ‘the alignment direction of liquid crystals of the liquid crystal cell, disposed toward the upper substrate’ may refer to a direction in which liquid crystals are aligned through rubbing or light irradiation, on a substrate of a liquid crystal cell, disposed toward a viewer. The absorption axis of the polarizer may refer to an optical axis thereof in a stretching direction, capable of absorbing light at the time of forming the polarizer by uniaxially stretching a PVA film dyed with iodine. When the absorption axis of the polarizer and the alignment direction of the liquid crystal cell are formed to satisfy the range of angle, excellent color sense and contrast ratio may be implemented.

Meanwhile, the polarizer may have a transmittance of 43 to 47%. In addition, the polarizer may have a color a value of −1 to −0.6 and a color b value of 0.3 to 2.5 in the CIE color coordinate system. In this case, the color a value and the color b value refer to values representing colors in the CIE color coordinate system, and more specifically, the color a value is calculated by a=500[(X/Xn)^{1/3}−(Y/Yn)^{1/3}] and +a denotes red while −a denotes green. In addition, the color b value is calculated by b=200[(Y/Yn)^{1/3}−(Z/Zn)^{1/3}] and +b denotes yellow while −b denotes blue (Here, Xn, Yn, and Zn correspond to X,Y and Z values of a reference white color).

The transmittance and color characteristics of the polarizer may be adjusted by adjusting an iodine concentration and performing a complementary color process at the time of manufacturing the polarizer, as described in the following Manufacturing Example. According to the inventors' research, in the case of using the polarizer having the above transmittance and color a and b values, a further neutral color may be realized in a white mode and a black mode.

Meanwhile, since the polarizer may have a significantly low thickness, the polarizing plate may be generally formed by attaching a protective film to one surface or two surfaces of the polarizer. In this case, as the protective film, protective films formed of various materials and commonly used in the technical field to which the present invention pertains may be used without limitation, and for example, a triacetyl cellulose (TAC) film, a cycloolefin film, an acrylic film, and the like may be used. The protective films may be attached to the polarizer using an adhesive or the like. In addition, the polarizing plate may further include an additional functional film such as a retardation film, a wide view angle compensation plate or a brightness enhancing film, in addition to the protective film, in order to improve further functions thereof.

Next, the ¼ wavelength plate may convert linearly polarized light having passed through the polarizing plate into circularly polarized light. As described above, the ¼ wavelength plate according to the embodiment of the present invention may be disposed so as to the optical axis thereof form an angle of 130° to 140°, preferably, an angle of 135°, with respect to the alignment direction of liquid crystals of the liquid crystal cell, disposed toward the upper substrate. Meanwhile, according to embodiments of the present invention, the optical axis of the ¼ wavelength plate may refer to an axis thereof in which two orthogonal components of light passing through the ¼ wavelength plate have the same electrical field intensity. In general, in the case of a retardation film, for example, when the film is uniaxially or biaxially stretched in order to form a phase difference, the optical axis refers to an axis in a direction in which the film is stretched.

Meanwhile, as the ¼ wavelength plate according to the embodiment of the present invention, a film having reverse wavelength dispersion characteristics may be used. In this case, the film having reverse wavelength dispersion characteristics may refer to a film having characteristics in which a phase retardation is increased in accordance with an increase in wavelength of light, and more specifically, may refer to a film satisfying the following formula (1).

Rin(450)<Rin(550)<Rin(650) Formula (1):

Here, Rin(λ) denotes an in-plane retardation value at a wavelength of λ nm. That is, Rin(450) denotes an in-plane retardation value at a wavelength of 450 nm, Rin(550) denotes an in-plane retardation value at a wavelength of 550 nm, and Rin(650) denotes an in-plane retardation value at a wavelength of 650 nm.

Meanwhile, according to the embodiment of the present invention, the in-plane retardation value Rin(λ) may refer to a value defined by the following formula (2), and a thickness direction retardation value Rth(λ) may refer to a value defined by the following formula (3).

Rin(λ)=(nₓ−n_{y})×d Formula (2):

Rth(λ)=(n_{z}−n_{y})×d Formula (3):

Here, nₓ denotes a refractive index in an in-plane slow axis direction of the ¼ wavelength plate, n_{y} denotes a refractive index in an in-plane fast axis direction of the ¼ wavelength plate, n_{z} denotes a refractive index in a thickness direction of the ¼ wavelength plate, and d denotes a thickness of the ¼ wavelength plate.

Meanwhile, the ¼ wavelength plate according to the embodiment of the present invention is not limited, but may have an in-plane retardation value Rin(550) of 120 nm to 170 nm at a wavelength of 550 nm. When the Rin(550) satisfies the numerical range, linearly polarized light may be smoothly converted into circularly polarized light in a visible ray area.

In addition, the ¼ wavelength plate according to the embodiment of the present invention is not limited, but may have a thickness direction retardation value Rth(550) of −20 to 150 nm at a wavelength of 550 nm. When the Rth (550) satisfies the numerical range, further superior viewing angle characteristics may be ensured.

More preferably, the ¼ wavelength plate according to the embodiment of the present invention may have wavelength dispersion characteristics satisfying the following formula (4) and formula (5).

0.5≦Rᵢₙ(450)/Rᵢₙ(550)<1.0 Formula (4)

1.0<Rᵢₙ(650)/Rᵢₙ(550)≦1.3 Formula (5)

Here, Rᵢₙ(450), Rᵢₙ(550), and Rᵢₙ(650) may respectively denote in-plane retardation values of the film at wavelengths of 450 nm, 550 nm, and 650 nm. According to the inventors' research, when the wavelength dispersion characteristics of the ¼ wavelength plate satisfy the following formula (3) and formula (4), neutral white and black color senses may be implemented and an excellent contrast ratio may be achieved. In general, a polarization variation of nRin(λ)/λ is generated while light passes through the ¼ wavelength plate. In the case of using a wavelength plate having normal or flat wavelength dispersion characteristics, polarization variations at wavelengths of 450 nm, 550 nm, and 650 nm may be shown as πRᵢₙ(450)/450>πRᵢₙ(550)/550>πRᵢₙ(650)/650, and thus, the polarization variations are increased toward short wavelengths. On the other hand, in the case of using the polarizing plate having reverse wavelength dispersion characteristics, similar levels of polarization variations may be generated regardless of wavelengths. However, even in the case of the polarizing plate having reverse wavelength dispersion characteristics, when Rᵢₙ(450)/Rᵢₙ(550) is excessively small or Rᵢₙ(650)/Rᵢₙ(550) is excessively large, a different in polarization variations may be caused to degrade the color sense. Thus, a wavelength plate satisfying the numerical range may be used.

Meanwhile, as long as the ¼ wavelength plate according to the embodiment of the present invention has reverse wavelength dispersion characteristics, a material thereof is not particularly limited. For example, the ¼ wavelength plate according to the embodiment of the present invention may be a uniaxially stretched polymer film, a liquid crystal film or the like, and more specifically, may be formed of a uniaxially stretched cycloolefin polymer(COP) film, a polycarbonate film, an acrylic film, a liquid crystal film or the like. In addition, the ¼ wavelength plate according to the embodiment of the present invention may be configured of a single film and may be in the form of a film laminate including two or more films laminated therein through a method such as coating, coextrusion, adhesion or the like.

More specifically, the ¼ wavelength plate having reverse wavelength dispersion characteristics according to the embodiment of the present invention may be formed of a polycarbonate film having a fluorene skeleton, manufactured by containing liquid crystals therein to form a film and then stretching the film; a cellulose acetate film manufactured by forming a film and stretching the film; a film manufactured by mixing an aromatic polyester polymer having normal wavelength dispersion characteristics and an aromatic polyester polymer having reverse wavelength dispersion characteristics to form a film and then stretching the film; a film manufactured by allowing a polymer configured of a copolymer including monomer units that form polymers having different wavelength dispersion characteristics to be formed as a film and then stretching the film; a complex film having two stretched films laminated therein, the stretched films having different wavelength dispersion characteristics; or the like.

As in the embodiment of the present invention, in the case of using the ¼ wavelength plate having reverse wavelength dispersion characteristics, further clear black color may be realized in a dark room mode, as compared to the case of using the ¼ wavelength plate having normal wavelength dispersion characteristics or flat wavelength dispersion characteristics. In the case of using the ¼ wavelength plate having normal wavelength dispersion characteristics or flat wavelength dispersion characteristics, since phase retardation is large at short wavelengths, a color shift phenomenon may be generated, resulting in a bluish phenomenon in which clear black color is not realized and blue color sense is exhibited in a dark room mode. However, in the case of using the ¼ wavelength plate having reverse wavelength dispersion characteristics, since the phase retardation is decreased toward short wavelengths, such a color shift phenomenon may be suppressed and consequently, clear black color may be implemented.

Next, the reflective liquid crystal display according to an embodiment of the present invention will be described. The reflective liquid crystal display according to the embodiment of the present invention may include an upper substrate, a lower substrate, a liquid crystal cell, a reflective plate, and a circular polarizing plate and in this case, the circular polarizing plate may be the circular polarizing plate according to the above-mentioned embodiment of the present invention.

More specifically, the reflective liquid crystal display according to the embodiment of the present invention may include the upper substrate, the lower substrate disposed to be opposed to the upper substrate, having a predetermined interval therebetween, the liquid crystal cell interposed between the upper substrate and the lower substrate, the reflective plate disposed between the lower substrate and the liquid crystal cell or disposed below the lower substrate, and the circular polarizing plate disposed on the upper substrate. The circular polarizing plate may include the polarizing plate including the polarizer having the absorption axis forming an angle of 85° to 95° with respect to the alignment direction of liquid crystals of the liquid crystal cell, disposed toward the upper substrate, and the ¼ wavelength plate positioned between the polarizing plate and the upper substrate and having the optical axis forming an angle of 130° to 140° with respect to the alignment direction of liquid crystals of the liquid crystal cell, disposed toward the upper substrate, wherein the ¼ wavelength plate has reverse wavelength dispersion characteristics.

In this case, the upper substrate and the lower substrate may be formed of a transparent material and for example, may be formed of glass or light-transmissive plastics.

Meanwhile, the upper substrate and the lower substrate may be opposed to each other, while having a predetermined interval therebetween, and switching elements may be formed on facing surfaces of the upper substrate and the lower substrate in order to drive the liquid crystal cell.

Meanwhile, the liquid crystal cell may be interposed between the upper substrate and the lower substrate and may be composed of liquid crystals having a positive dielectric anisotropy. A driving mode for the liquid crystal cell may be varied depending on an arrangement of the liquid crystals within the liquid crystal cell and a driving state thereof. In general, various modes of liquid crystal cells such as twisted nematic (TN) type crystal cells, supertwisted nematic (STN) type crystal cells, polymer dispersed liquid crystal (PDLC) type crystal cells, electrically controlled birefringence (ECD) type crystal cells, in-plane switching (IPS) type crystal cells and the like, may be used for the reflective liquid crystal display. In consideration of viewing angle aspects, the reflective liquid crystal display according to the embodiment of the present invention may be an electrically controlled birefringence (ECB) mode liquid crystal display or an in-plane switching (IPS) mode liquid crystal display, but the present invention is not limited thereto.

Meanwhile, according to the embodiment of the present invention, a liquid crystal cell gap of the liquid crystal display may be about 2.0 to 2.4 μm. When the liquid crystal cell gap is within the range of about 2.0 to 2.4 μm, the greatest improvement in white color may be exhibited. In the case that an appropriately sized cell gap as described above is not formed, a difference in paths taken by transmitted light and reflective light may be generated, such that light efficiency may be changed to cause chrominance.

The reflective plate is provided to reflect light incident thereon from the outside of the liquid crystal display to thereby enable the light to be used as a light source. The reflective plate may be disposed between the lower substrate and the liquid crystal cell or disposed below the lower substrate. The reflective plate may be manufactured through a deposition of a conductive material, for example, aluminum, silver or the like.

Meanwhile, the circular polarizing plate according to the foregoing embodiment of the present invention may be used in the reflective liquid crystal device according to the embodiment of the present invention. That is, the circular polarizing plate may include the polarizing plate including the polarizer having the absorption axis forming an angle of 85° to 95°, preferably, 90°, with respect to the alignment direction of liquid crystals of the liquid crystal cell, disposed toward the upper substrate, and the ¼ wavelength plate positioned between the polarizing plate and the upper substrate and having the optical axis forming an angle of 130° to 140°, preferably, 135°, with respect to the alignment direction of liquid crystals of the liquid crystal cell, disposed toward the upper substrate, wherein the ¼ wavelength plate has reverse wavelength dispersion characteristics. The detailed description of the circular polarizing plate is the same as that described above, it will be omitted.

### MODE FOR INVENTION

Hereinafter, the present invention will be described in detail with reference to concrete examples. The following concrete examples may, however, be provided for further understanding of the invention and thus, the content of the invention should not be construed as being limited to the examples.

### Manufacturing Example

After PVA films (by Kuraray Co. Ltd., degree of polymerization: 2400) were subjected to a water bath and a swelling bath and were dyed in an aqueous solution including I₂ and KI, the dyed PVA films were stretched 5 times in an aqueous solution containing boric acid and KI to manufacture polarizers. In this case, a concentration of and a temperature of a dyeing bath are shown in the following [Table 1]. In addition, in order to adjust colors of the polarizers, a KI solution concentration was adjusted to a level of about 2 to 4% in a complementary color process.

Thereafter, a triacetyl cellulose (TAC) film having a thickness of 60 μm was positioned on both surfaces of polarizers. After an aqueous PVA-based adhesive solution may be interposed between the polarizer and the TAC film to form a laminate using a laminator, the laminate was dried at 80° C. for 8 minutes, such that polarizing plates were manufactured.

### Experimental Example 1

Transmittances and colors of the polarizing plates manufactured by the Manufacturing Example were measured using a spectrophotometer (Device Name: N&K). Measured results are shown in the following [Table 1].

TABLE 1

| Stretching | | | | | | | |
|---|---|---|---|---|---|---|---|
| Temperature | Norm. | | | | | | |
| (° C.) | I₂(pt) | I₂(pt) | a | b | Ts | Tc | Ac |
| 48 | 1.00 | 0.079 | −1.14 | 3.00 | 0.4203 | 0.00033 | 3.48 |
| | 0.70 | 0.055 | −0.92 | 2.41 | 0.4316 | 0.00138 | 2.86 |
| | 0.50 | 0.040 | −0.79 | 1.82 | 0.4418 | 0.00719 | 2.14 |
| | 0.30 | 0.024 | −0.69 | 1.24 | 0.4719 | 0.04805 | 1.32 |
| 53 | 1.00 | 0.095 | −1.50 | 3.16 | 0.4132 | 0.00019 | 3.72 |
| | 0.39 | 0.037 | −0.94 | 1.42 | 0.4464 | 0.00979 | 2.01 |
| | 0.27 | 0.026 | −1.05 | 0.70 | 0.4929 | 0.08232 | 1.08 |

* Norm. I₂: Relative Iodine Concentration
I₂: Iodine Concentration
Ts: Single Body Transmittance
Tc: Cross Transmittance
Ac = −log(Tc), Absorbance

According to the [Table 1], it could be confirmed that the iodine concentration was adjusted, such that the transmittances and colors of the polarizing plates could be appropriately adjusted.

### Comparative Example 1

A circular polarizing plate was manufactured by sequentially stacking a ¼ wavelength plate having Rin(550)=140 nm and Rth(550)=10 nm and a ½ wavelength plate having Rin(550)=270 nm on a polarizing plate having a transmittance of 42%. In this case, as the ¼ wavelength plate, a film having Rin(450)=140.5 nm, Rin(550)=140 nm, and Rin(650)=139.6 nm were used, the film being formed of a COP material and having flat wavelength dispersion characteristics. Here, the ¼ wavelength plate was stacked such that an optical axis thereof had an angle of 75° with respect to the absorption axis of the polarizing plate, and the ½ wavelength plate was stacked such that an optical axis thereof had an angle of 15° with respect to the absorption axis of the polarizing plate.

The circular polarizing plate manufactured as above was attached to a surface of an IPS mode reflective LCD panel. In this case, an alignment direction of liquid crystals of the LCD panel, disposed toward an upper substrate, was 45° with respect to a length direction of the LCD panel, and the circular polarizing plate was attached to the LCD panel such that the absorption axis of the circular polarizing plate formed an angle of 90° with respect to the alignment direction of the liquid crystals.

### Comparative Example 2

A circular polarizing plate was manufactured by attaching a ¼ wavelength plate having Rin(550)=130 nm, Rth(550)=−9 nm, Rin(450)=130.5 nm, and Rin(650)=129.6 nm to a polarizing plate having a transmittance of 45%, the ¼ wavelength plate being formed of a COP material and having flat wavelength dispersion characteristics. In this case, the ¼ wavelength plate was attached to the polarizing plate such that an optical axis thereof formed an angle of 45° with respect to an absorption axis of the polarizing plate.

The circular polarizing plate manufactured as above was attached to a surface of an IPS mode reflective LCD panel. In this case, an alignment direction of liquid crystals of the LCD panel, disposed toward an upper substrate, was 45° with respect to a length direction of the LCD panel, and the circular polarizing plate was attached to the LCD panel such that the absorption axis of the circular polarizing plate formed an angle of 90° with respect to the alignment direction of the liquid crystals.

### Comparative Example 3

A circular polarizing plate was manufactured by attaching a ¼ wavelength plate having Rin(550)=140 nm, Rth(550)=10 nm, Rin(450)=140.5 nm, and Rin(650)=139.6 nm to a polarizing plate having a transmittance of 45%, the ¼ wavelength plate being formed of a COP material and having flat wavelength dispersion characteristics. In this case, the ¼ wavelength plate was attached to the polarizing plate such that an optical axis thereof formed an angle of 45° with respect to an absorption axis of the polarizing plate.

The circular polarizing plate manufactured as above was attached to a surface of an IPS mode reflective LCD panel. In this case, an alignment direction of liquid crystals of the LCD panel, disposed toward an upper substrate was 45° with respect to a length direction of the LCD panel, and the circular polarizing plate was attached to the LCD panel such that the absorption axis of the circular polarizing plate formed an angle of 90° with respect to the alignment direction of the liquid crystals.

### Comparative Example 4

A circular polarizing plate was manufactured by attaching a ¼ wavelength plate having Rin(550)=140 nm, Rth(550)=10 nm, Rin(450)=140.5 nm, Rin(650)=139.6 nm to a polarizing plate having a transmittance of 41%, the ¼ wavelength plate being formed of a COP material and having flat wavelength dispersion characteristics. In this case, the ¼ wavelength plate was attached to the polarizing plate such that an optical axis thereof formed an angle of 45° with respect to an absorption axis of the polarizing plate.

The circular polarizing plate manufactured as above was attached to a surface of an IPS mode reflective LCD panel. In this case, an alignment direction of liquid crystals of the LCD panel, disposed toward an upper substrate, was 45° with respect to a length direction of the LCD panel, and the circular polarizing plate was attached to the LCD panel such that the absorption axis of the circular polarizing plate formed an angle of 90° with respect to the alignment direction of the liquid crystals.

### Comparative Example 5

A circular polarizing plate was manufactured by attaching a ¼ wavelength plate having Rin(550)=110 nm, Rth(550)=3 nm, Rin(450)=110.4 nm, and Rin(650)=109.7 nm to a polarizing plate having a transmittance of 45%, the ¼ wavelength plate being formed of a COP material and having flat wavelength dispersion characteristics. In this case, the ¼ wavelength plate was attached to the polarizing plate such that an optical axis thereof formed an angle of 45° with respect to an absorption axis of the polarizing plate.

The circular polarizing plate manufactured as above was attached to a surface of an IPS mode reflective LCD panel. In this case, an alignment direction of liquid crystals of the LCD panel, disposed toward an upper substrate, was 45° with respect to a length direction of the LCD panel, and the circular polarizing plate was attached to the LCD panel such that the absorption axis of the circular polarizing plate formed an angle of 90° with respect to the alignment direction of the liquid crystals.

### Comparative Example 6

A circular polarizing plate was manufactured by attaching a ¼ wavelength plate having Rin(550)=130 nm, Rth(550)=−9 nm, Rin(450)=130.5 nm, and Rin(650)=129.6 nm to a polarizing plate having a transmittance of 45%, the ¼ wavelength plate being formed of a COP material and having flat wavelength dispersion characteristics. In this case, the ¼ wavelength plate was attached to the polarizing plate such that an optical axis thereof formed an angle of 45° with respect to an absorption axis of the polarizing plate.

The circular polarizing plate manufactured as above was attached to a surface of an IPS mode reflective LCD panel. In this case, an alignment direction of liquid crystals of the LCD panel, disposed toward an upper substrate, was 45° with respect to a length direction of the LCD panel, and the circular polarizing plate was attached to the LCD panel such that the absorption axis of the circular polarizing plate formed an angle of 45° with respect to the alignment direction of the liquid crystals.

### Example 1

A circular polarizing plate was manufactured by attaching a ¼ wavelength plate having Rin(550)=140 nm, Rth(550)=10 nm, Rin(450)=124.5 nm, and Rin(650)=143.6 nm to a polarizing plate having a transmittance of 45%, the ¼ wavelength plate being formed of a polycarbonate material and having reverse wavelength dispersion characteristics. In this case, the ¼ wavelength plate was attached to the polarizing plate such that an optical axis thereof formed an angle of 45° with respect to an absorption axis of the polarizing plate.

The circular polarizing plate manufactured as above was attached to a surface of an IPS mode reflective LCD panel. In this case, an alignment direction of liquid crystals of the LCD panel, disposed toward an upper substrate, was 45° with respect to a length direction of the LCD panel, and the circular polarizing plate was attached to the LCD panel such that the absorption axis of the circular polarizing plate formed an angle of 90° with respect to the alignment direction of the liquid crystals.

### Experimental Example 2

In LCD devices manufactured according to Comparative Examples 1 to 3 and 6 and Example 1, color senses in a white mode and a black mode were macroscopically compared and measured.

As a result of the measurement, in the case of the LCD device to which the circular polarizing plate having a reflective circular polarizing plate structure (commonly, now on the market; that is, a structure having a ¼ wavelength plate and a ½ wavelength plate) according to Comparative Example 1 was attached, there was a defect in which white color had a yellowish tone. Meanwhile, in the case of Comparative Examples 2, 3 and 6, using the ¼ wavelength plates having flat wavelength dispersion characteristics, neutral white color was implemented in a white mode while neutral black color was not implemented and green, red or blue color sense was shown in a black mode. On the other hand, in the case of Example 1, neutral white color and neutral black color were shown in a white mode and a black mode, respectively.

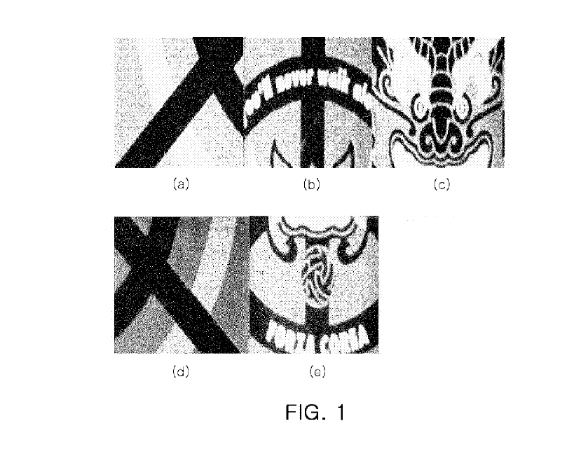

FIG. 1 shows photographs illustrating the color senses according to Comparative Examples 1 to 3 and 6 and Example 1 in a black mode. FIG. 1(a) is a photograph illustrating the color sense according to Comparative Example 1, FIG. 1(b) is a photograph illustrating the color sense according to Comparative Example 2, FIG. 1(c) is a photograph illustrating the color sense according to Comparative Example 3, FIG. 1(d) is a photograph illustrating the color sense according to Comparative Example 6, and FIG. 1(e) is a photograph illustrating the color sense according to Example 1, in a black mode.

With reference to FIG. 1, it could be confirmed that in the cases of the LCD devices to which the circular polarizing plates according to Comparative Examples 1 to 3 and 6 are attached, green, red, or blue color sense was shown in a black mode to deteriorate black color sense. In particular, in the case of Comparative Example 6 in which an angle between the liquid crystal cell and the absorption axis of the polarizing plate was 45°, it could be confirmed that the blue color sense was significantly shown in a black mode. On the other hand, in the case of the LCD device to which the circular polarizing plate according to Example 1 was attached, as illustrated in FIG. 1 (e), neutral black color sense was implemented.

### Experimental Example 3

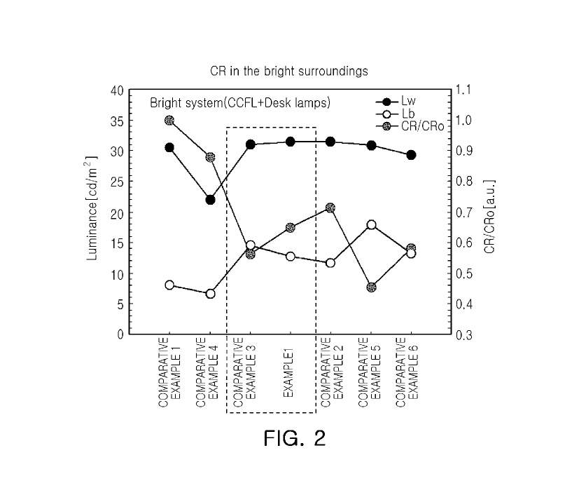

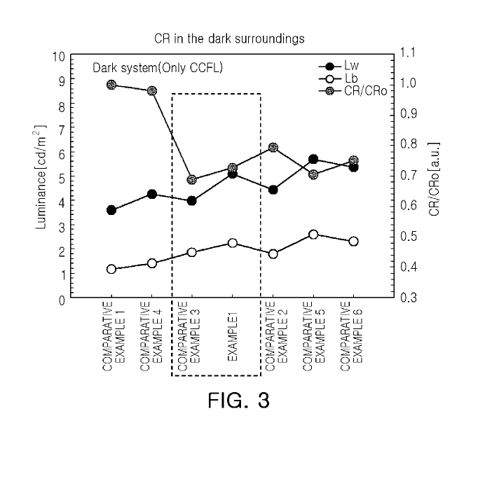

In IPS mode reflective LCD devices manufactured according to Comparative Examples 1 to 6 and Example 1, luminances of black and white in a light room and a dark room were measured using a luminance meter to calculate contrast ratios. The measured results in a light room are illustrated in FIG. 2 and the measured results in a dark room are illustrated in FIG. 3.

In FIGS. 2 and 3, line Lw refers to the luminance of white color, line Lb refers to the luminance of black color, and luminance values are illustrated on the left of the graph. Moreover, line CR/CRo refers to contrast ratios (CR/CRo) and values of contrast ratios (CR/CRo) are illustrated on the right of the graph. Meanwhile, Lwₒ, Lbₒ, CRₒ are measured values of the case in which the circular polarizing plate according to Comparative Example 1 is attached.

Meanwhile, contrast ratios of the case (Comparative Example 3) in which the ¼ wavelength plate having the in-plane retardation value of 140 nm and flat wavelength dispersion characteristics was attached to the polarizing plate having a transmittance of 45% and the case (Example 1) in which the ¼ wavelength plate having the in-plane retardation value of 140 nm and reverse wavelength dispersion characteristics was attached to the polarizing plate having a transmittance of 45%, are shown in square dotted lines of FIGS. 2 and 3. As shown in the square dotted lines of FIGS. 2 and 3, when the ¼ wavelength plate having flat wavelength dispersion characteristics and the ¼ wavelength plate having reverse wavelength dispersion characteristics have an identical retardation value to each other, in the case of using the ¼ wavelength plate having reverse wavelength dispersion characteristics, the contrast ratios (CR/CRo) in both of a light room and a dark room were higher as compared to the case of using the ¼ wavelength plate having flat wavelength dispersion characteristics. That is, when all experimental conditions are identical and the wavelength dispersion characteristics of the ¼ wavelength plate are merely different, it could be confirmed that the contrast ratios (CR/CRo) of the circular polarizing plate in which the ¼ wavelength plate having the in-plane retardation value of 140 nm and reverse wavelength dispersion characteristics was attached to the polarizing plate, as in the embodiment of the present invention, were higher as compared to the other cases.

### Experimental Example 4

In order to detect contrast ratios depending on thickness direction retardation values of a ¼ wavelength plate, contrast ratios according to variations in the thickness direction retardation value Rth of the ¼ wavelength plate at a wavelength of 550 nm were measured through simulations, at an viewing angle (θ) of 75° and azimuthal angles (φ) of 15°, 30°, 45°, 60°, and 75°, respectively. In this case, conditions were set such that a transmittance of a polarizing plate was 43%, the ¼ wavelength plate satisfied Rin(550)=140 nm, a liquid crystal cell was an IPS mode LDC, a retardation value of an IPS liquid crystal was about 300 nm, and a pretilt angle of the liquid crystal was 2°. As a simulation program, TechWiz LCD was used.

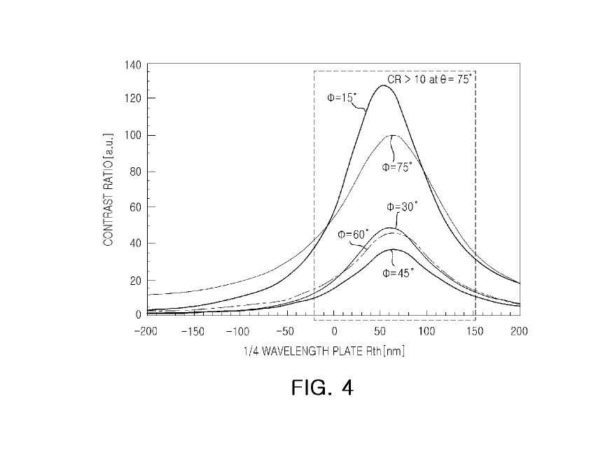

The simulation results are shown in FIG. 4. As illustrated in FIG. 4, when Rth (550) of the ¼ wavelength plate ranged from −20 nm to 150 nm, it could be confirmed that values of contrast ratios were 10 or more, excellent, at all azimuthal angles.

While the present invention has been shown and described in connection with the embodiments, it will be apparent to those skilled in the art that modifications and variations can be made without departing from the spirit and scope of the invention as defined by the appended claims.

1. A circular polarizing plate, comprising:
a polarizing plate including a polarizer having an absorption axis forming an angle of 85° to 95° with respect to an alignment direction of liquid crystals of a liquid crystal cell, disposed toward an upper substrate, and
a ¼ wavelength plate having an optical axis forming an angle of 130° to 140° with respect to the alignment direction of the liquid crystals of the liquid crystal cell, disposed toward the upper substrate,
wherein the ¼ wavelength plate has reverse wavelength dispersion characteristics.

2. The circular polarizing plate of claim 1, wherein the ¼ wavelength plate satisfies formula (4) and formula (5).
0.5≦Rᵢₙ(450)/Rᵢₙ(550)<1.0 Formula (4)
1.0<Rᵢₙ(650)/Rᵢₙ(550)<1.3 Formula (5)
where, Rᵢₙ(450) denotes an in-plane retardation value at a wavelength of 450 nm,
Rᵢₙ(550) denotes an in-plane retardation value at a wavelength of 550 nm, and
Rᵢₙ(650) denotes an in-plane retardation value at a wavelength of 650 nm.

3. The circular polarizing plate of claim 1, wherein the polarizer has a transmittance of 43 to 47%.

4. The circular polarizing plate of claim 1, wherein the polarizer has a color a value of −1 to −0.6 and a color b value of 0.3 to 2.5 in a CIE color coordinate system.

5. The circular polarizing plate of claim 1, wherein the ¼ wavelength plate is a uniaxially stretched film.

6. The circular polarizing plate of claim 1, wherein the ¼ wavelength plate is selected from a group consisting of a uniaxially stretched cycloolefin polymer (COP) film, a polycarbonate (PC) film, a liquid crystal film, and an acrylic film.

7. The circular polarizing plate of claim 1, wherein the ¼ wavelength plate has a thickness direction retardation value of −20 to 150 nm at a wavelength of 550 nm.

8. The circular polarizing plate of claim 1, wherein the ¼ wavelength plate has an in-plane retardation value of 120 to 170 nm at a wavelength of 550 nm.

9. A reflective liquid crystal display, comprising:
an upper substrate;
a lower substrate disposed to be opposed to the upper substrate, having a predetermined interval therebetween;
a liquid crystal cell interposed between the upper substrate and the lower substrate,
a reflective plate disposed between the lower substrate and the liquid crystal cell or disposed below the lower substrate; and
the circular polarizing plate of claim 1, disposed on the upper substrate.

10. The reflective liquid crystal display of claim 9, wherein the reflective liquid crystal display is an in-plane switching (IPS) mode liquid crystal display or an electrically controlled birefringence (ECB) mode liquid crystal display.
